(19) United States
(12) Patent Application Publication
(10) Pub. No.: US 2014/0233160 A1
(43) Pub. Date: Aug. 21, 2014

(54) Load Centers Including Position Sensing Circuits and Related Systems and Sensing Circuits

(71) Applicant: EATON CORPORATION, Cleveland, OH (US)

(72) Inventors: Vincent Ferri, Pittsburgh, PA (US); David Raymond Rohn, Venetia, PA (US)

(21) Appl. No.: 13/770,326

(22) Filed: Feb. 19, 2013

(51) Int. Cl. H02B 5/00; G01B 7/00

(52) U.S. Cl. CPC H02B 5/00; G01B 7/003
USPC 361/627; 324/76.11

(57) ABSTRACT

Electrical distribution panels are provided that are configured to receive a smart breaker. The electrical distribution panel includes a frame; at least one bus line coupled to the frame; a position sensing circuit associated with a breaker position of the electrical distribution panel, the position sensing circuit being configured to provide a unique electrical parameter associated with the breaker position; and a communications circuit coupled to the position sensing circuit and configured to communicate information pertaining to the unique electrical parameter to an external recipient when the smart breaker is positioned in the electrical distribution panel to provide an address for a device associated with the breaker position.

### FIELD

The inventive concept relates generally to electrical distribution panels, such as load centers and, more particularly, to identification in smart devices connected to the load centers.

### BACKGROUND

Electrical distribution panels, such as load centers, house the electrical connections between the incoming power lines of an electric power distribution system and the numerous branch circuits in an installation, such as a residence, light commercial facility or industrial facility. Additional protection, such as surge protection, may be provided in some load centers. Typically, a load center will have a main circuit breaker as well as separate circuit breakers for each of the branch circuits.

The electrical distribution panel, or load center, typically includes an enclosure including a branch circuit assembly, also commonly referred to as the interior, which typically includes a pair of line buses secured by a support insulator to the rear wall of the enclosure. The circuit breakers connect each branch hot conductor to one of the line buses, or to both buses in the case of a two pole breaker. The branch circuit assembly also includes one or more neutral terminal blocks to which the branch circuit neutral conductors are secured.

In many conventional systems, the electrical distribution panels or load centers and the circuit breakers may include communication circuits that allow remote monitoring and maintenance of the electronic power system in the installation.

### SUMMARY

Some embodiments of the inventive concept provide an electrical distribution panel configured to receive a smart breaker. The electrical distribution panel includes a frame; at least one bus line coupled to the frame; a position sensing circuit associated with a breaker position of the electrical distribution panel, the position sensing circuit being configured to provide a unique electrical parameter associated with the breaker position; and a communications circuit coupled to the position sensing circuit and configured to communicate information pertaining to the unique electrical parameter to an external recipient when the smart breaker is positioned in the electrical distribution panel to provide an address for a device associated with the breaker position.

In further embodiments, the electrical distribution panel may be a load center.

In still further embodiments, the position sensing circuit may be one of a resistor, an inductor, a capacitor, a zener diode or any device that has a unique value that can represent the breaker position.

In some embodiments, the electrical distribution panel may be a plurality of breaker positions and the electrical distribution panel may further include a plurality of position sensing circuits. Each of the plurality of position sensing circuits may be associated with one of the plurality of breaker positions and have a unique electrical parameter for the one of the plurality of breaker positions. Each of the plurality of breaker positions may be associated with one of a plurality of devices and each of the plurality of devices may be assigned an address based on the unique electrical parameter for the breaker position associated therewith.

In further embodiments, the plurality of position sensing circuits may include a plurality resistors having unique values associated with each of the plurality of breaker positions.

In still further embodiments, voltage may not be present at the position sensing circuit until the smart breaker is positioned in the load center.

In some embodiments, a value of the unique electrical parameter may not have an overall affect on an associated electrical distribution system.

Further embodiments of the present inventive concept provide position sensing circuits including an identifying element associated with a breaker position in a load center. The identifying element is configured to provide a unique electrical parameter associated with the breaker position. The unique electrical parameter is communicated to an external recipient when a smart breaker is positioned in the load center to provide an address for a device associated with the breaker position.

Still further embodiments of the present inventive concept provide an electrical distribution system including a load center and a smart breaker. The load center includes at least one bus line and having at least one position sensing circuit associated with a breaker position of load center. The at least one position sensing circuit is configured to provide a unique electrical parameter associated with the breaker position. The smart breaker is configured to be received by the load center and configured to obtain information pertaining to the unique electrical parameter when the smart breaker is positioned in the load center and to provide the unique electrical parameter to an external recipient to provide an address for a device associated with the breaker position.

### BRIEF DESCRIPTION OF THE DRAWINGS

FIG. 1 is a block diagram of an electrical distribution system in accordance with some embodiments of the present inventive concept.

FIG. 2 is a block diagram of a position sensing element in accordance with some embodiments of the inventive concept.

FIG. 3 is a block diagram of an electrical distribution system in accordance with some embodiments of the present inventive concept.

FIG. 4 is a block diagram of a system including a load center and a smart breaker in accordance with some embodiments of the present inventive concept.

FIG. 5 is a block diagram of a system including a communications device, a load center and a smart breaker in accordance with some embodiments of the present inventive concept.

FIG. 6 is a block diagram of a data processing system that may be used in combination with the load center and the smart breaker in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. In the drawings, the relative sizes of regions or features may be exaggerated for clarity. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As discussed above, electrical distribution panels house the electrical connections between the incoming power lines of an electric power distribution system and the numerous branch circuits in an installation, such as a residence, light commercial facility or industrial facility. Additional protection, such as surge protection, may be provided in some load centers. Typically, a load center will have a main circuit breaker as well as separate circuit breakers for each of the branch circuits. Furthermore, in many conventional systems, the electrical distribution panels or load centers and the circuit breakers may include communication circuits that allow remote monitoring and maintenance of the electronic power system in the installation. However, when a smart breaker having communication capability is placed in the electrical distribution system, associations need to be made between the breaker positions of a smart device or breaker so that addresses can be assigned to each breaker position. It may be difficult for the smart breaker to identify the positions within the breaker panel.

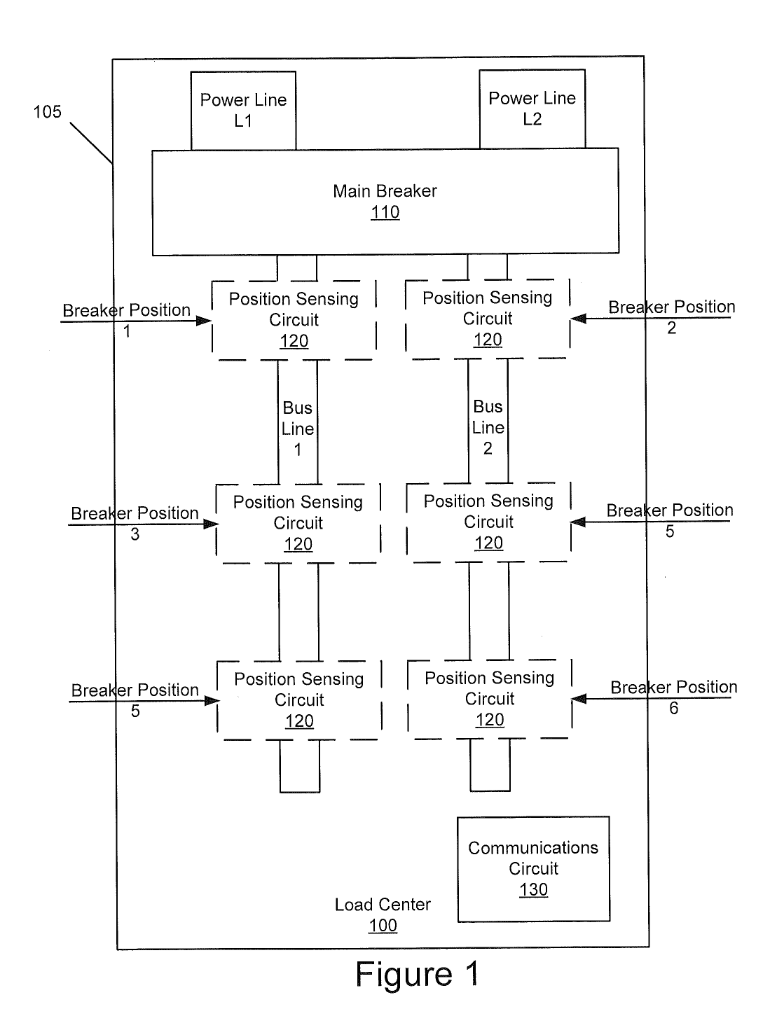

Accordingly, some embodiments of the present inventive concept provide position sensing circuits associated with positions in the electrical distribution system configured to receive the smart breaker. Thus, when the smart device is “plugged in” to the electrical distribution system, the smart device will receive position information from the position sensing circuit at each breaker position and the system can associate the breaker position of the devices, the types of devices and number of devices installed with the electronic distribution system. Thus, according to some embodiments of the present inventive concept, remote monitoring of smart devices may be facilitated because the administrator will know exactly which breaker position in the smart breaker each device is associated with as will be discussed further herein with respect to FIGS. 1 through 6.

Although embodiments of the present inventive concept will be discussed herein with respect to the electrical distribution panel being a load center, embodiments of the present inventive concept will not be limited to this configuration. For example, an electrical distribution panel may be a panelboard, or any other suitable indoor or outdoor panel for distributing electrical power to a number of electrical loads without departing from the scope of the present inventive concept.

Furthermore, although the term “plugged in” is used herein to describe how the smart device/smart breaker attaches to the load center, embodiments of the present inventive concept are not limited to this configuration. The smart device/smart breaker may be attached to the load center using any known method without departing from the scope of the present inventive concept.

Referring now to FIG. 1, a block diagram of an electrical distribution panel or load center in accordance with some embodiments of the present inventive concept will be discussed. As illustrated in FIG. 1, the load center 100 includes an enclosure 105. The enclosure includes 2 power lines L1 and L2, a main breaker 110 coupled to first and second bus lines 1 and 2 and a plurality of breaker positions 1-6 connected to the bus lines 1 and 2. As further illustrated in FIG. 1, each breaker position 1-6 in the load center 100 has an associated position sensing circuit 120 in accordance with embodiments of the present inventive concept.

It will be understood that although the load center 100 is shown as including a single main breaker 110 and six breaker positions, embodiments of the present inventive concept are not limited to this configuration. For example, load centers can incorporate two or more circuit breakers to provide a safe and controllable distribution of electric power. Each of the circuit breakers can have forty or more breaker positions without departing from the scope of the present inventive concept. Such load centers 100 have become a common feature in both residential and commercial structures.

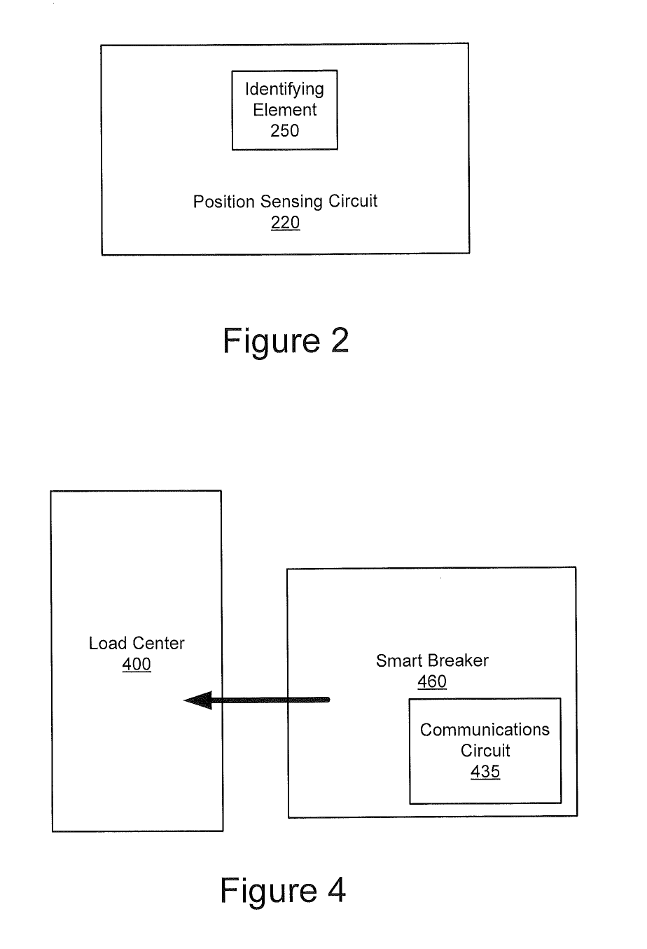

Referring now to FIGS. 1 and 2, each position sensing circuit 120, 220 includes an identifying element 250. The identifying element 250 of the position sensing circuit 120, 220 is placed in a position within the load center 100 that will interface with the smart device/smart breaker when it is “plugged in.” Thus, these identifying elements 250 can be used by the system to associate the position, type and number of devices installed in the load center 100. The identifying element 250 can be any element that can be assigned a unique value (unique electrical parameter) that will not affect the functionality of the overall system. For example, the identifying element 250 can be, but is not limited to, a resistor, an inductor, a capacitor, a zener diode or any device that has a unique value that can represent the breaker position.

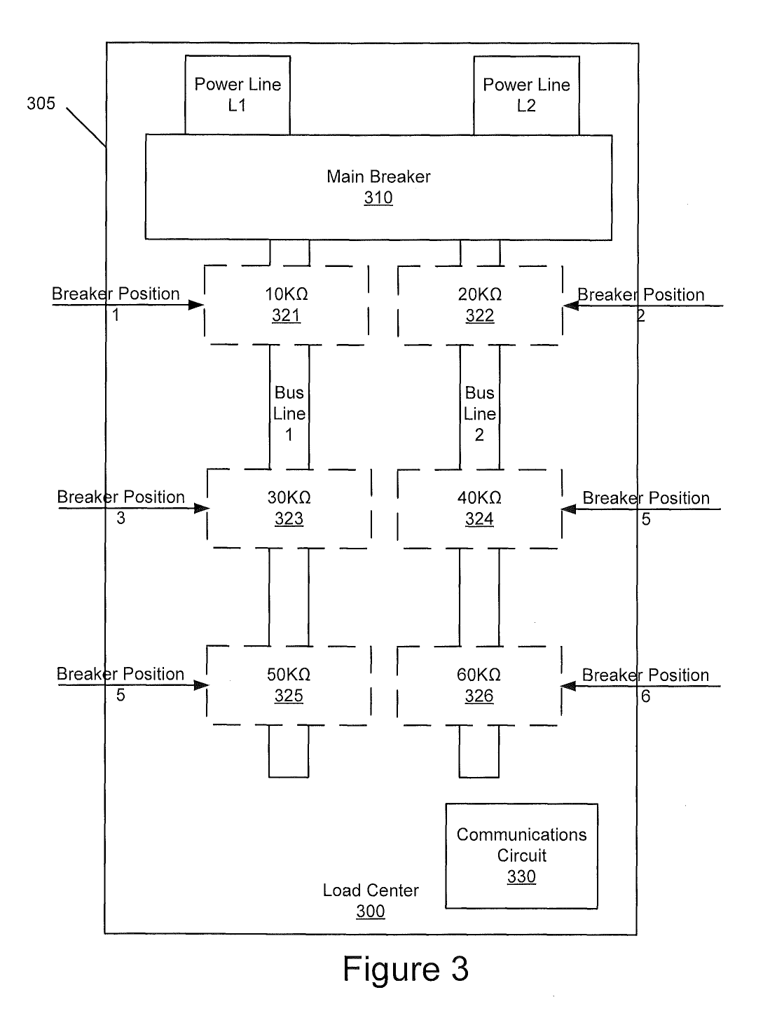

Embodiments of the present inventive concept where the identifying element 250 of the position sensing circuit 120, 220 is a resistor will now be discussed with respect to FIG. 3. As illustrated in FIG. 3, the load center 300 includes an enclosure 305. The enclosure includes 2 power lines L1 and L2, a main breaker 310 coupled to first and second bus lines 1 and 2 and a plurality of breaker positions 1-6 connected to the bus lines 1 and 2. As further illustrated in FIG. 3, each breaker position 1-6 in the load center 300 has an associated position sensing circuit including a resistor 321, 322, 323, 324, 325, 326 as the identifying element in accordance with embodiments of the present inventive concept.

When the smart breaker is plugged in to the load center 300, the device assumes an address based on the position and value of the resistor 321, 322, 323, 324, 325, 326 associated therewith. For example, as illustrated in FIG. 3 breaker position 1 has a 10KΩ resistor 321 associated therewith; breaker position 2 has a 20KΩ resistor 322 associated therewith; breaker position 3 has a 30KΩ resistor 323 associated therewith; breaker position 4 has a 40KΩ resistor 324 associated therewith; breaker position 5 has a 50KΩ resistor 325 associated therewith; and breaker position 6 has a 60KΩ resistor 326 associated therewith. Thus, when a device is installed in, for example, breaker position 6, the device assumes an address 6 based upon the resistor value (60KΩ) of that position.

Thus, each position sensing circuit (220 of FIG. 2) assumes a unique value associated with the breaker position within the panel. In embodiments illustrated in FIG. 3, each breaker position 1-6 is assigned a unique resistor value. The smart device assumes a unique address within the load center 300 based on the unique value assigned to the position associated therewith. The unique value, i.e. resistor value, is read by the smart device using low level voltages that are not harmful and cannot be accessed by the end user when the smart device is installed. No voltage is present on a position sensing circuit 220 when the smart device is removed from the load center 300.

In some embodiments, the resistors 321, 322, 323, 324, 325, 326 are powered by the smart device/smart breaker from a low voltage and may be mounted in a position not accessible by the end user, for example, the home owner. Voltage is not present on the device when the smart breaker is not installed in the load center 300.

In some embodiments, the resistor 321, 322, 323, 324, 325, 326 may be encapsulated in a non-conducting compound, such as epoxy. The resistor 321, 322, 323, 324, 325, 326 may be mounted to the bottom of the load center 300 in all positions available for the smart breaker, for example, positions 1-6 of FIG. 3. The devices mount to the base of the load center with the use of, for example, a screw located on the bottom of the position sensing circuit (220 of FIG. 2) and the breaker via, for example, a plug in stab. The connection to the smart breaker is accomplished automatically when the smart breaker is snapped or plugged in to position within the load center 300. FIG. 4 is a block diagram illustrating that the smart breaker including a communications circuit 460 is configured to snap in or be plugged in to the load center 400 as discussed above. The screw end of the position sensing circuit (220 of FIG. 2) would connect to one lead of a resistor 321, 322, 323, 324, 325, 326 located within the encapsulation cover and the stab would be connected to the remaining lead of the resistor 321, 322, 323, 324, 325, 326.

Embodiments of the present inventive concept are not limited to the encapsulated resistor/screw embodiments discussed above. For example, in some embodiments, the resistor may be silk screened to the load center in the relative positions thereon. Any method may be used without departing from the scope of the present inventive concept.

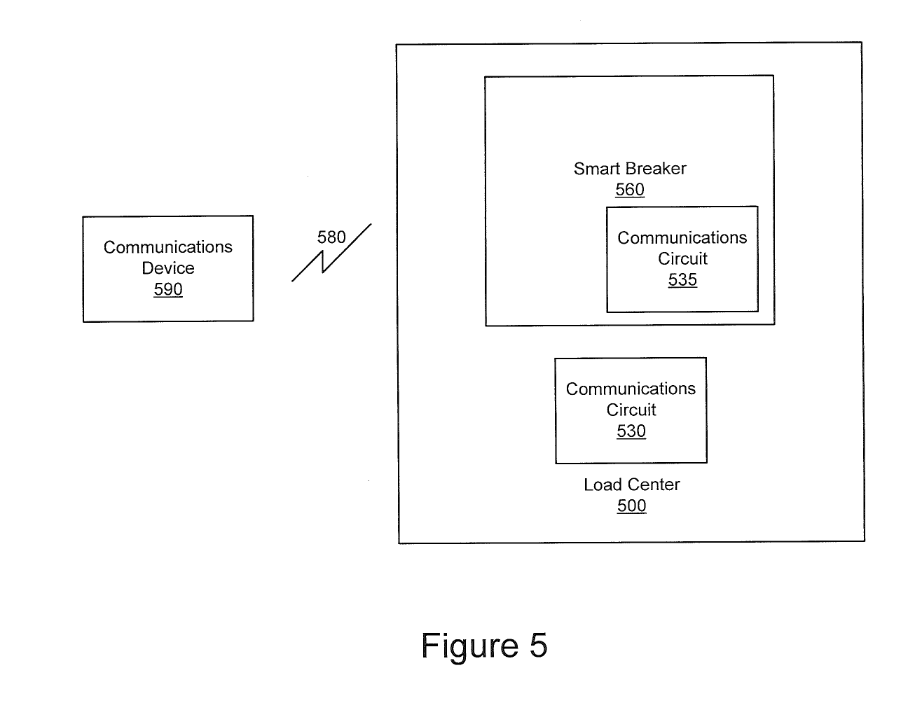

Referring now to FIG. 5, a system in accordance with some embodiments of the present inventive concept will be discussed. As illustrated in FIG. 5, the system includes a communications device 590 and a load center 500. The load center includes a smart breaker 560 installed therein and both the load center 500 and the smart breaker 560 have associated communications circuits 530 and 535, respectively. The smart breaker 560 includes position sensing circuits at each breaker position as discussed above. The communications device 590 communicates with the load center 500 and the smart breaker 560 via the communications circuits 530 and 535, respectively, over a connection 580. The connection 580 may be wired or wireless without departing from the scope of the present inventive concept.

Due to the presence of the communications circuits 530,535, smart breakers can be used to turn off/turn on individual circuits in an electrical panel remotely, monitor and report energy usage and provide monitoring and control. For example, a wireless signal, such as a ZigBee wireless signal, may be sent from a controller at the communications device 590 to the load center 500, which is wired to the breaker. The wireless signal may indicate that a particular circuit should be turned on or off. For example, a solenoid on the breaker may be configured to turn off the circuit without physically “tripping” the circuit. The capability of remote monitoring and maintenance using smart load centers and devices may be useful in operating big appliances like air conditioners, water heaters or pool pumps as well as other equipment.

In some embodiments, circuits may also be programmed to shut off or turn on automatically based on programmed schedules or in response to pricing signals from the utility. In particular, utilities offering smart grid services may implement Time of Use rates that price electricity higher during peak load periods, such as dinnertime. Many utilities will opt to delay or “load shift” the energy used by their appliances and EV chargers to other, less expensive times.

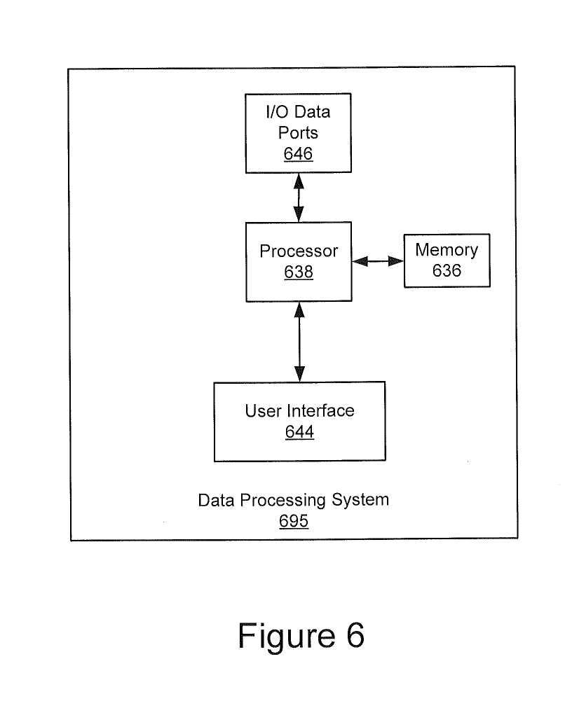

Referring now to FIG. 6, a data processing system 695 that may be included in one of more of the communications device 590, the smart breaker 560 and load center 500 in accordance with some embodiments will be discussed. As illustrated in FIG. 6, the data processing system 695 may include a user interface 644, including, for example, input device(s) such as a man machine interface (MMI) including, but not limited to a keyboard or keypad and a touch screen; a display; a speaker and/or microphone; and a memory 636 that communicate with a processor 638. The data processing system 695 may further include I/O data port(s) 646 that also communicates with the processor 638. The I/O data ports 646 can be used to transfer information between the data processing system 695 and another computer system or a network, such as an Internet server, using, for example, an Internet Protocol (IP) connection. These components may be conventional components such as those used in many conventional data processing systems, which may be configured to operate as described herein.

As discussed briefly above, some embodiments of the present inventive concept provide systems and methods for associating a smart breaker/smart device to an installation position within a load center. As discussed, this association may allow the smart breaker to assign position type and address of a device within a smart communications system. Thus, some embodiments of the present inventive concept, may reduce, or possibly eliminate, the need for switches or special software discovery algorithms to detect and decode the position of a smart breaker within the load center.

Example embodiments are described above with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a field programmable gate array (FPGA), or a programmed digital signal processor, a programmed logic controller (PLC), or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed:

1. An electrical distribution panel configured to receive a smart breaker, the electrical distribution panel comprising:
a frame;
at least one bus line coupled to the frame;
a position sensing circuit associated with a breaker position of the electrical distribution panel, the position sensing circuit being configured to provide a unique electrical parameter associated with the breaker position; and
a communications circuit coupled to the position sensing circuit and configured to communicate information pertaining to the unique electrical parameter to an external recipient when the smart breaker is positioned in the electrical distribution panel to provide an address for a device associated with the breaker position.

2. The electrical distribution panel of claim 1, wherein the electrical distribution panel comprises a load center.

3. The electrical distribution panel of claim 2, wherein the position sensing circuit comprises one of a resistor, an inductor, a capacitor, a zener diode and any device having a unique value.

4. The electrical distribution panel of claim 2:
wherein the electrical distribution panel comprises a plurality of breaker positions, the electrical distribution panel further comprising a plurality of position sensing circuits, each of the plurality of position sensing circuits being associated with one of the plurality of breaker positions and having a unique electrical parameter for the one of the plurality of breaker positions; and
wherein each of the plurality of breaker positions are associated with one of a plurality of devices and wherein each of the plurality of devices is assigned an address based on the unique electrical parameter for the breaker position associated therewith.

5. The electrical distribution panel of claim 4, wherein the plurality of position sensing circuits comprise a plurality resistors having unique values associated with each of the plurality of breaker positions.

6. The electrical distribution panel of claim 2, wherein voltage is not present at the position sensing circuit until the smart breaker is positioned in the load center.

7. The electrical distribution panel of claim 2, wherein a value of the unique electrical parameter does not have an overall affect on an associated electrical distribution system.

8. A position sensing circuit comprising:
an identifying element associated with a breaker position in a load center, the identifying element being configured to provide a unique electrical parameter associated with the breaker position,
wherein the unique electrical parameter is communicated to an external recipient when a smart breaker is positioned in the load center to provide an address for a device associated with the breaker position.

9. The position sensing circuit of claim 8, wherein the identifying element having the unique electrical parameter comprises one of a resistor, an inductor, a capacitor, a zener diode and any device having a unique value.

10. The position sensing circuit of claim 8, wherein voltage is not present at the position sensing circuit until the smart breaker is positioned in the load center.

11. The electrical distribution panel of claim 8, wherein a value of the unique electrical parameter does not have an overall affect on an associated electrical distribution system.

12. The position sensing circuit of claim 8, wherein the breaker position is associated with a device and wherein the device is assigned an address based on the unique electrical parameter for the breaker position associated therewith.

13. An electrical distribution system comprising:
a load center including at least one bus line and having at least one position sensing circuit associated with a breaker position of load center, the at least one position sensing circuit being configured to provide a unique electrical parameter associated with the breaker position; and
a smart breaker configured to be received by the load center and configured to obtain information pertaining to the unique electrical parameter when the smart breaker is positioned in the load center and to provide the unique electrical parameter to an external recipient to provide an address for a device associated with the breaker position.

14. The electrical distribution system of claim 13, wherein the at least one position sensing circuit comprises one of a resistor, an inductor, a capacitor, a zener diode and any device having a unique value.

15. The electrical distribution system of claim 13:
wherein the load center includes a plurality of position sensing circuits, each of the plurality of position sensing circuits being associated with one of a plurality of breaker positions and each having a unique electrical parameter for the one of the plurality of breaker positions associated therewith; and
wherein each of the plurality of breaker positions are associated with one of a plurality of devices and wherein each of the plurality of devices is assigned an address based on the unique electrical parameter for the breaker position associated therewith.

16. The electrical distribution system of claim 15, wherein the plurality of position sensing circuits comprise a plurality resistors having unique values associated with each of the plurality of breaker positions.

17. The electrical distribution system of claim 13, wherein voltage is not present at the position sensing circuit until the smart breaker is positioned in the load center.

18. The electrical distribution system of claim 13, wherein a value of the unique electrical parameter does not have an overall affect on an associated electrical distribution system.
